(19) United States
(12) Patent Application Publication
(10) Pub. No.: US 2020/0246927 A1
(43) Pub. Date: Aug. 6, 2020

(54) TWO TABLE SLIDING ROTATING ROBOTIC POSITIONING SYSTEM

(71) Applicant: Genesis Systems Group, LLC, Davenport, IA (US)

(72) Inventors: Jan Christian Mangelsen, Charlotte, IA (US); Michael S. Jacobsen, Davenport, IA (US); Terry L. Daggett, Blue Grass, IA (US); Michael P. Skahill, Pleasant Valley, IA (US)

(21) Appl. No.: 16/855,672

(22) Filed: Apr. 22, 2020

Related U.S. Application Data
(63) Continuation of application No. 15/699,709, filed on Sep. 8, 2017.
(60) Provisional application No. 62/385,849, filed on Sep. 9, 2016.

(51) Int. Cl. B23Q 3/18; B23Q 1/66; B23Q 3/16

(52) U.S. Cl. CPC B23Q 3/18; G05B 2219/45135; B23Q 3/16; B23Q 1/66

(57) ABSTRACT

A positioning system includes a centrally mounted robot within a work area. Workpiece holders are independently moveable relative to the robot between working positions on opposite sides of the robot and a shared loading and unloading position. The system permits the robot to continuously operate without a need to wait for movement between the loading position and the working position. Furthermore, the system can be used as a single workpiece system while maintenance or hardware change is being performed on one of the workpiece holders. The workpiece holders move between the work positions and the loading and unloading position in a rotation and sliding fashion.

### CROSS-REFERENCE TO RELATED APPLICATIONS

This application is a continuation application of U.S. Ser. No. 15/699,709, filed Sep. 8, 2017, which claims priority to Provisional Application U.S. Ser. No. 62/385,849, filed Sep. 9, 2016, all of which are herein incorporated by reference in their entirety.

### FIELD OF THE INVENTION

This invention relates generally to robotic positioning systems or workstations, and in particular, to a positioning system that uses two tables that alternatingly move between a work position and a loading/unloading position.

### BACKGROUND OF THE INVENTION

Many manufacturing processes have become automated. Typically, robots consist of a single mechanical arm that has a limited number of axes about which the arm can move or rotate. The robot arm has a tool, such as a welder, attached to the end of the arm. Because the robotic arm is limited as to where it can reach, modem assembly lines also provide work tables, or positioning modules that hold fixtures and parts, that can be moved to position a product being worked on by the robotic arm within the reach of the arm. One common design utilizes a stationary robot mounted with access to a work area, and a turntable to move workpieces into the work area. Two workpiece mounting structures are located 180° across from each other on the rotatable turntable which moves the work pieces between the work station and the load/unload station. The load/unload station is curtained off from the work area, such that a user can load and unload one workpiece while the robot is working on the other workpiece. This design suffers from a disadvantage in that the robot generally cannot perform work while the turntable is indexing or rotating. This down time during indexing can add up to a significant reduction in the efficiency of the system as compared to a system that permits a robot to work at all times.

In another prior art robotic work station, sliding workpiece holders are used, which allows the robot to move between two workpieces, and thus operate substantially continuously. However, these sliding workpiece holders are loaded/unloaded at two separate points, thus requiring an operator to walk or shuttle between points, rather than being stationed at a single location to load and unload both workpiece holders.

Furthermore, the same robot may be used to work on different types of workpieces. This can require a change in the mounting hardware used on the indexing system. In traditional turntable indexing systems, the system must be shut down during the exchange of hardware. The same is true if maintenance or repair needs to be performed on the fixture hardware. The down time for exchange or maintenance of workpiece mounting hardware represents a loss in efficiency for the system.

The present invention provides a positioning system that permits the robot to work continuously, without needing to remain idle as with the index time for a turntable. The result is increased efficiency. Additionally, the present invention permits the system to run during fixture changeover and maintenance, which also improves the efficiency of the system. The invention utilizes a single loading and unloading point or station for dual moveable workpiece holders, thereby saving the operator steps and time. The present invention is also designed to have improved safety for workers and to have a compact footprint.

### SUMMARY OF THE INVENTION

According to one embodiment, the present invention is directed to a positioning system that includes a centrally mounted robot within a work area. A first workpiece holder is attached to a first linkage, whereby the first linkage is adapted to translate and rotate the first workpiece holder between a first working position within the work area and a loading and unloading position outside the work area, and wherein the loading and unloading position is rotated about 90 degrees from the first working position. A second workpiece holder is attached to a second linkage, whereby the second linkage is adapted to translate and rotate the second workpiece holder between a second working position within the work area and to the loading and unloading position outside the work area, and wherein the loading and unloading position is rotated about 90 degrees from the second working position.

The present invention is also directed toward a method of performing sequential robotic operations on at least two workpieces. In this method, the first workpiece is loaded on a first workpiece holder at a first end of the workstation, and then moved to the first side of the workstation wherein work is performed on the first workpiece by a robot. As the robot is working on the first workpiece, a second workpiece is loaded on a second holder at the first end of the workstation, and then moved to a second side of the workstation, opposite of the first side of the workstation. After the robotic work on the first workpiece is completed, the first holder is moved to the first end of the workstation and the workpiece is unloaded, while simultaneously the robot performs work on the second workpiece on the second side of the workstation. The first work holder can be reloaded with a new workpiece as a robot works on the second workpiece. The first work holder with the new workpiece is then moved back to the first side of the workstation. When work on the second workpiece is completed, the second holder is moved to the end of the workstation for unloading and reloading while work begins on the new workpiece of the first holder.

### DESCRIPTION OF THE DRAWINGS

FIG. 1 is a perspective view of the two-table sliding and rotating robotic positioning system according to the present invention, with a pair of workpieces shown in broken lines, and with the two work holders both located in working stations on opposite sides of the robot.

FIG. 2 is a perspective view of the system, with the workpieces removed for clarity.

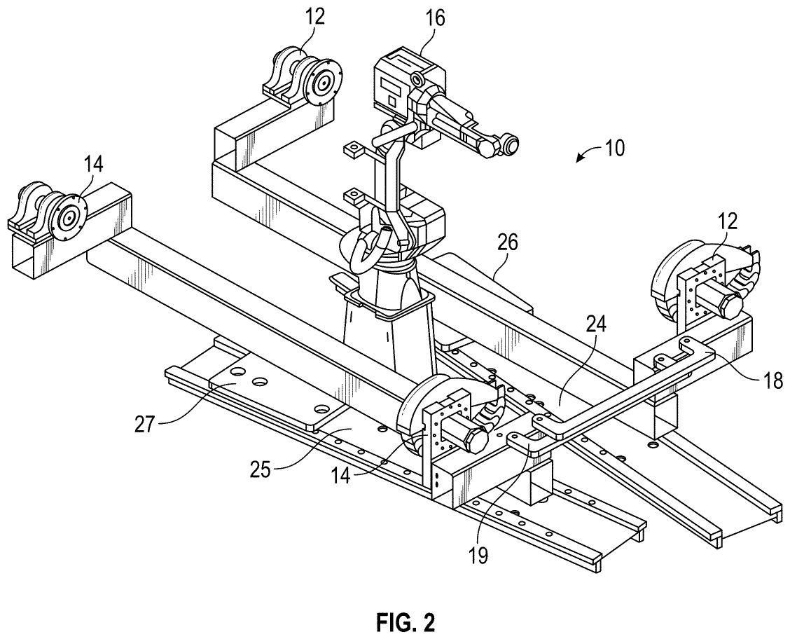

FIG. 3 is a top plan view of the system shown in FIG. 2.

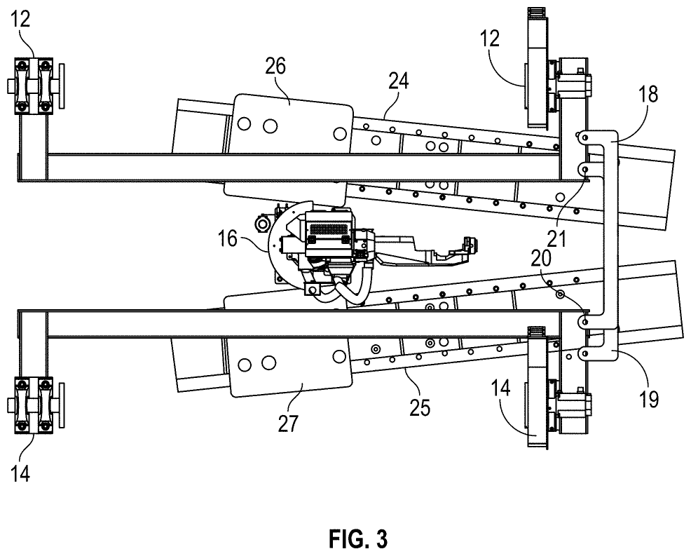

FIG. 4 is a perspective view of the system with the first workpiece holder moved to a loading/unloading position and the second workpiece holder moved to a work position.

FIG. 5 is a view similar to FIG. 4, with the work holders moved to opposite positions.

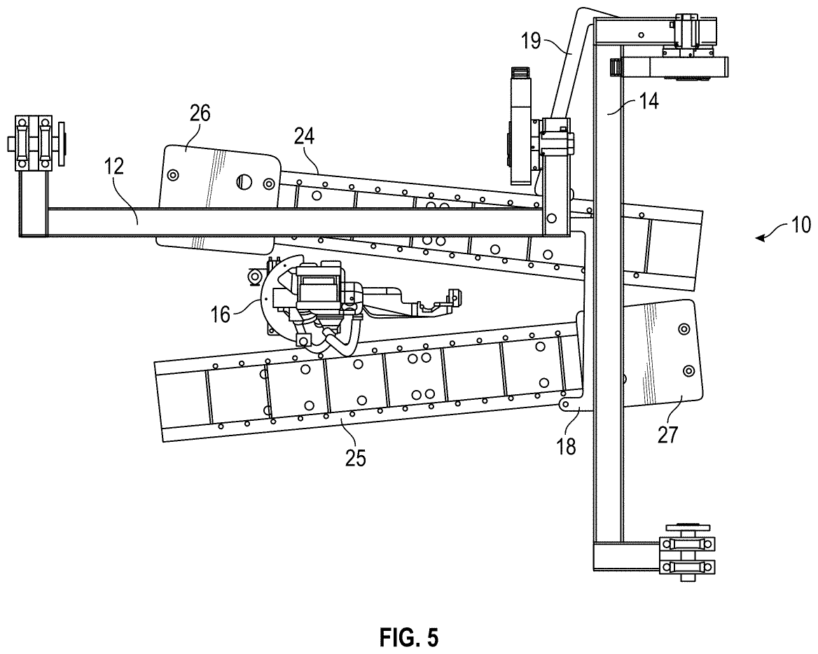

FIG. 6 is a perspective view similar to FIG. 4, with the workpieces being removed from the work holders.

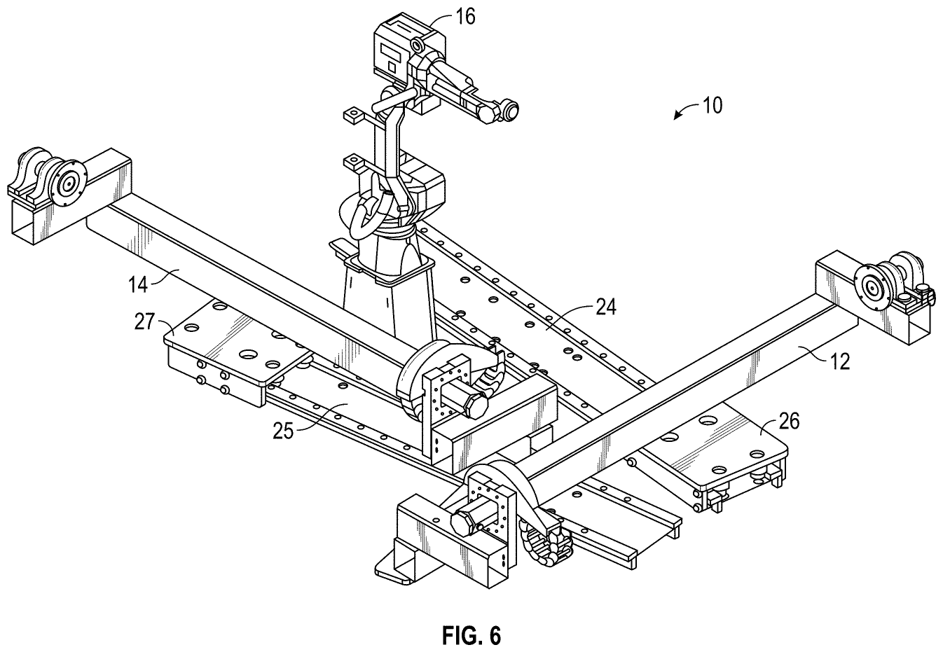

FIG. 7 is a top plan view of the system shown in FIG. 6.

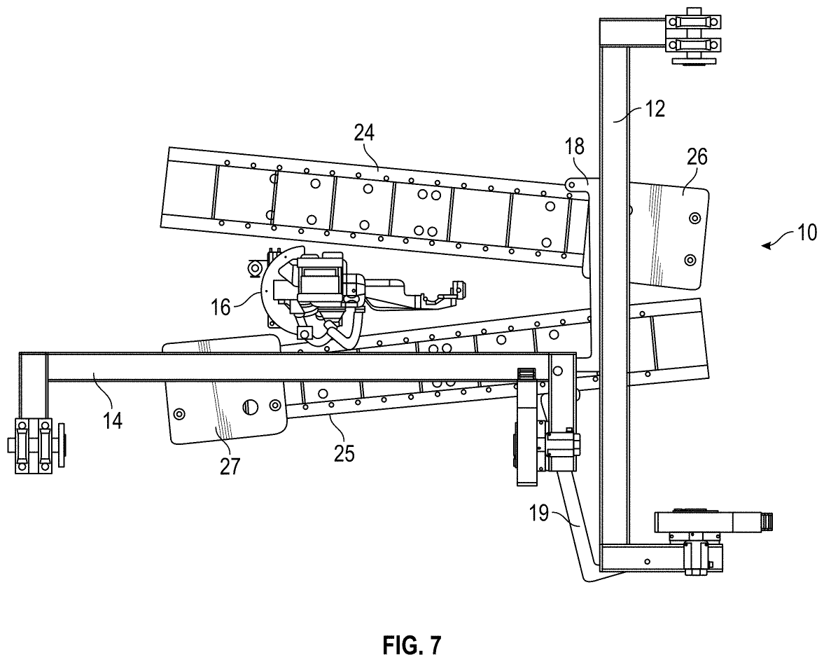

FIG. 8 is a perspective view of one of the tracks and track followers for the system, according to the present invention.

FIG. 9 is an end elevation view of the track and track follower shown in FIG. 8.

FIG. 10 is a partially exploded view of the track and track follower.

FIG. 11 is a plan view of an alternative embodiment of the present invention utilizing a pair of converging tracks for moving the workpiece holders.

### DETAILED DESCRIPTION OF THE PREFERRED EMBODIMENTS

The robotic positioning system or workstation 10 according to one embodiment of the present invention includes a first workpiece holder 12 and a second workpiece holder 14 each adapted to hold a workpiece 15. The workpiece holders 12, 14 can be tables or trunnions, or other known workpiece mounting structures of various sizes and shapes. The workpieces 15 are shown generically in the drawings as cylindrical bodies, though the workpieces may have various sizes and shapes, and are mounted on the holder 12, 14 in any convenient manner.

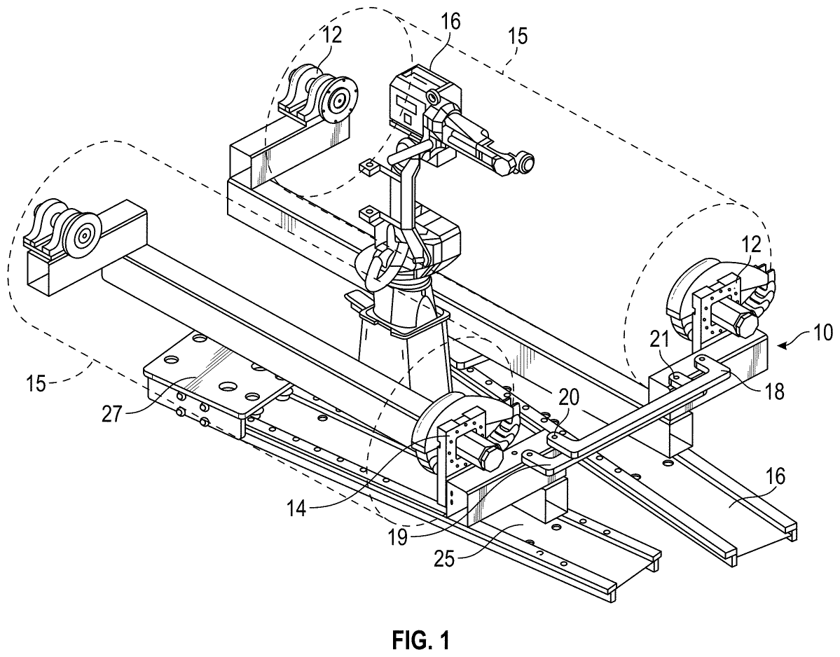

The workpiece holders 12, 14 are both shown in their respective working positions on opposite sides of a robot 16 in FIG. 1. The robot 16 may include tools to perform work on the workpieces 15 supported on the workpiece holders 12 and 14. For example, the robot 16 may include a welder. Each of the workpiece holders 12 and 14 are attached to their own linkage or link arms 18 and 19. While the linkages 18 and 19 are represented by a single bar in FIG. 1, in practice, the linkages may include several components. The linkages 18 and 19 are adapted to move the workpiece holders 12, 14 between their respective working positions on opposite sides of the workstation 10 and the loading and unloading position at one end of the workstation 10.

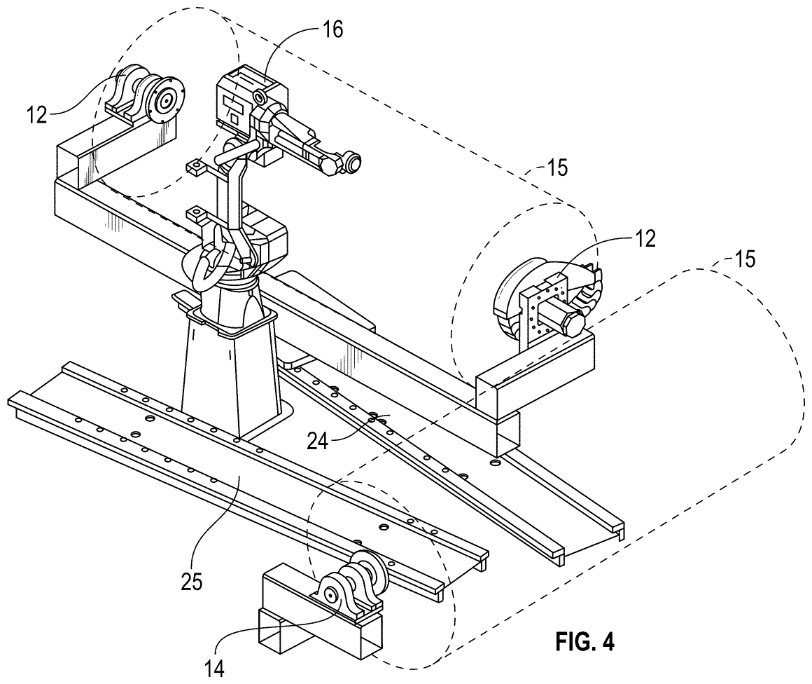

More specifically, the linkages 18, 19 are adapted to move the workpiece holders 12, 14 in a sliding and rotating fashion so that the footprint of the system 10 is minimized, and so that as each workpiece holder 12, 14 moves between the positions, it does not interfere with the other workpiece holder. For example, the first workpiece holder 12 has a vertical pivot axis 20 to rotate along a pivot arc. The first workpiece holder 12 also slides along a track 24 via a track follower or base 26. As the first workpiece holder 12 moves from the working position shown in FIG. 1 to the loading and unloading position shown in FIG. 4, the follower or base 26 will move along track 24 and the link arm 18 will move along the arc. Similarly, the second workpiece holder 14 has a pivot axis 21 to rotate along a pivot arc, and a follower or base 27 to slide along a track 25. As seen in FIGS. 1 and 4, in the loading and unloading position 100 the workpiece holders 12 and 14 are rotated approximately 90 degrees from their working positions. The workpiece holders 12 and 14 may be provided with curtains or other shielding so that when the holders 12 and 14 are in their working positions, the loading and unloading area is protected from sparks, light, and heat that may be generated by the work being performed by the robot 16.

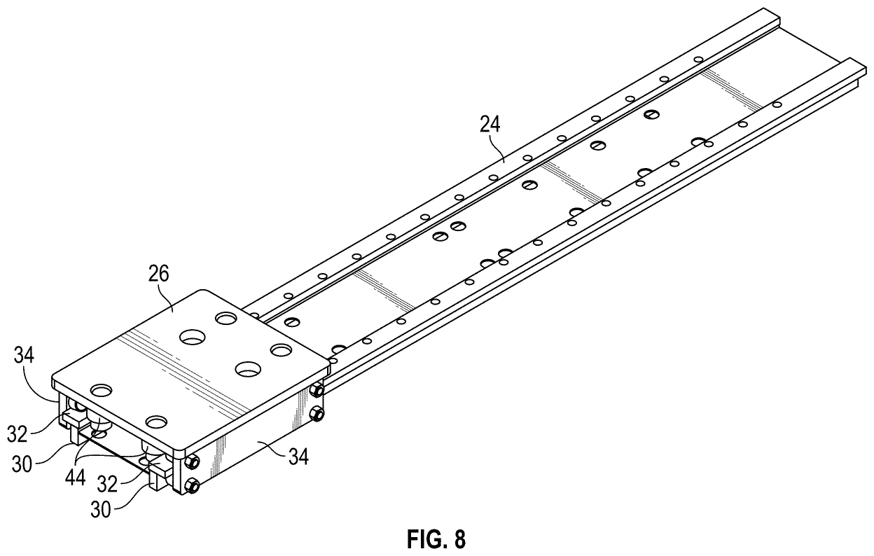

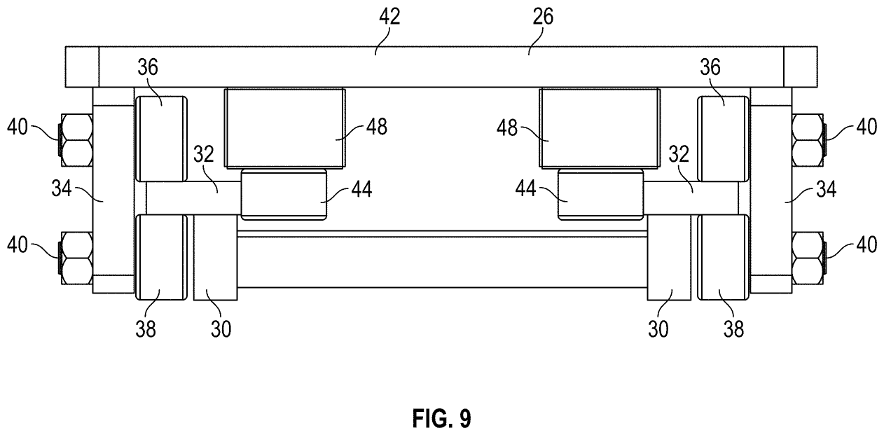

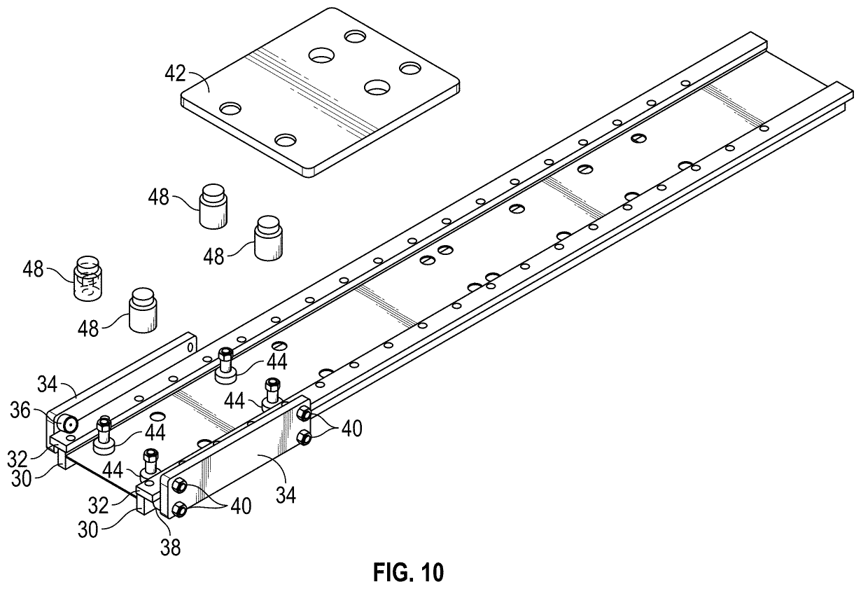

The tracks 24, 25 and track followers 26, 27 may take various forms. FIGS. 8-10 show one form for the track and track follower. More particularly, each track includes opposite longitudinal rails 30, with each rail having an upper plate or flange 32 extending laterally outwardly. The follower 26 has opposite sides 34 to which an upper roller 36 and lower roller 38 are mounted via bolts or pins 40. The rollers 36, 38 track along the upper and lower surfaces of the flange 32. The follower 26 also has an upper plate 42 with the plurality of the rollers 44 connected to the plate 42 by vertical bolts or pins 46. Spacers 48 may be provided between the rollers 44 and the bottom surface of the plate 42. The rollers 42 roll along the inside edge of the track flanges 32.

It is understood that the track and track follower may take other forms and configurations without departing from the scope of the present invention.

The movement of the holders 12, 14 between the work position and the loading unloading position is preferably done automatically, but may also be done manually. In the preferred operation, holder movement is controlled by a computer which actuates an actuator (not shown) to move the holders 12, 14. The actuator may be linear, such as hydraulic or pneumatic cylinders connected to the track followers 26, 27, or an electric motor or gear system connected to the link arms 18, 19 to rotate the arms.

In operation, a user will be stationed at the loading and unloading area at the end of the system 10 to load and unload work pieces from the workpiece holders 12 and 14. The workpiece holders 12 and 14 can move independently of one and other. Therefore, while one of the holders 12 or 14 is in the loading and unloading position, the other holder 12 or 14 can be in the working position on one or the other side of the robot 16, with the robot 16 performing work on the workpiece. For example, a user can unload a finished first workpiece and load a new third workpiece on to the first workpiece holder 12 in the loading and unloading position 100 while the robot 16 is performing work on a workpiece on the second workpiece holder 14 at the second work position on the second side of the robot 16. Preferably, the robot 16 remains stationary as the work is done on each of the workpieces 15. The work piece holders 12,14 are isolated from each other so any vibration created by unloading or loading a new work piece 15 on one of the holders at the end of the work station is not induced into the other work piece at one of the side work stations. Also, during work by the robot 16, the holder 12 or 14 with the work piece being worked upon remains stationary in the preferred embodiment, though the position of the work piece in the work holder may be changed as the robot works on the piece. Alternatively, the robot may be moved around the workpiece during the work, as controlled by a software program.

As soon as the new workpiece is loaded on to the first workpiece holder 12, the user can cause the first workpiece holder 12 to move back to the first working position on the first side of the robot 16 without interrupting the welding or other process being performed by the robot 16 on the second workpiece on workpiece holder 14. Once the robot 16 finishes its operations on the second workpiece on the second workpiece holder 14, the robot can be moved to the opposite work position on the opposite side of the work station, and then immediately, and without interruption, begin working on the third workpiece on the first workpiece holder 12 at the first work position. The second workpiece holder 14 can move to the loading and unloading position 100 while the robot 16 is working on the third workpiece on the first workpiece holder 12. In this fashion, the robot 16 can be kept in constant operation without the need for downtime to permit indexing between the loading and working positions. It should be appreciated that to enjoy the full benefit of this feature, it is necessary that the loading and unloading procedure and the time to move between the working and loading and unloading positions must take less cumulative time than the working operation being performed by the robot 16

The system 10 also permits changing mounting hardware or performing maintenance on one of the workpiece holders 12 and 14 without complete interruption of the robotic work on a workpiece on the other holder. To accomplish this feature, the system 10 is operated as a single station positioner with the workpiece holder that is being repaired or maintained remaining stationary in the working position while the other workpiece holder remains operational. For example, a maintenance worker could perform maintenance on the second work piece holder 14 in the second working position, while the first workpiece holder 12 moves back and forth between the first working position and the loading and unloading position.

The sliding and rotating motion of the workpiece holders 12,14 facilitates retaining the workpiece holders 12, 14 close to the robot 16 in their working positions while still avoiding interference with each other as they move to the loading and unloading position 100. Furthermore, the compound movement helps minimize the overall footprint of the workstation 10 in a relatively compact area. One benefit of the system 10 is that it permits the workpieces to be located very close to the robot 16, which is desirable for efficiency. The loading and unloading area can be located farther away from the robot 16, which is desirable for safety reasons.

The system 10 also has the flexibility to be used as a two-station stationary system with two loading and loading stations being located adjacent to the working positions. In that mode, only the robot 16 would move, and loading and unloading of workpieces would be performed on opposite sides of the system 10 without movement to the end of the workstation 10.

As a further alternative, the link arms 18, 19 can be at opposite ends of the holders 12, 14, such that the holders 12, 14 move to opposite ends of the workstation (though this will increase the footprint of the system).

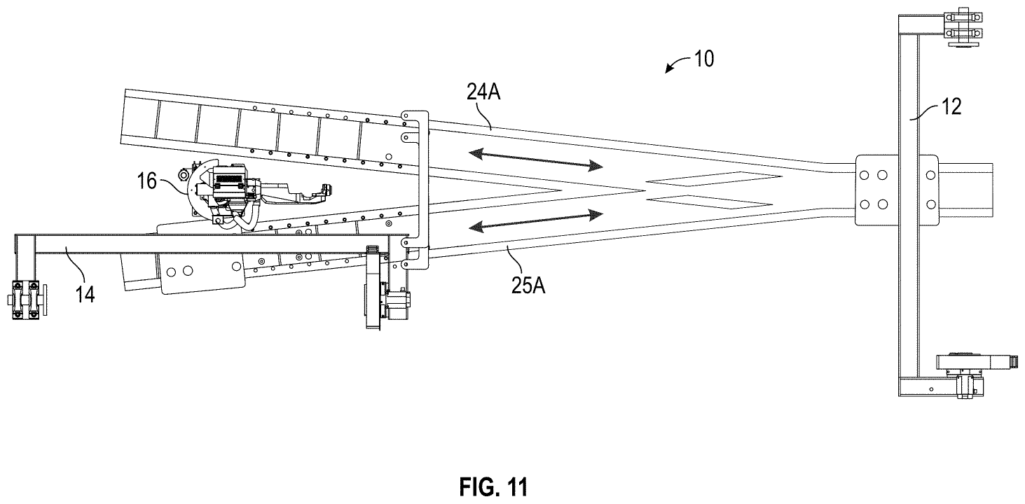

Another alternative is shown in FIG. 11, wherein a pair of tracks 24A, 25A extend from opposite sides of the robot 16 to a common load/unload station at one end of the workstation 10. The workpiece holders 12, 14 can move along the tracks 24A. 25A, such that as the robot works on one workpiece, the other workpiece holder can be moved to the end for unloading the completed workpiece and inserting a new workpiece, in a manner similar to that described above. As seen in FIG. 11, the workpiece holders 12, 14 can be rotated approximately 90° from the end loading/unloading station to the side work positions. Movement of the holders 12, 14 can be rolling, sliding, or any other convenient means.

In all embodiments, movement of the holders 12, 14 can be controlled automatically by computer software. Manual movement of the holders is also contemplated by the invention, though is not preferred.

The presently preferred embodiments of the invention have been described with a degree of particularity. The previous description is of preferred examples for implementing the invention only, and the scope of the invention should not necessarily be limited by this description. The scope of the invention is defined by the scope of the following claims.

What is claimed is:

1. A method of positioning workpieces for robotic work, comprising:
loading a first workpiece in a first station onto a first holder;
moving the first holder and first workpiece to a first workstation;
performing robotic work on the first workpiece in the first workstation while the first workpiece is on the first holder;
loading a second workpiece in the first station onto a second holder while the robotic work is performed on the first workpiece;
moving the first holder and first workpiece after the robotic work is completed from the first workstation back to the first station as the second workpiece and second holder move from the first station to a second workstation;
unloading the first work piece in the first station;
performing robotic work on the second workpiece in the second workstation while the second workpiece is on the second holder; then
moving the second workpiece and second holder to the first station and unloading the second workpiece from the second holder.

2. The method of claim 1 wherein the holders hold the workpieces as the robotic work is performed.

3. The method of claim 1 wherein the first and second workstations are separate from one another.

4. The method of claim 1 wherein the robotic work on the first and second workpieces is done at different times.

5. The method of claim 1 further comprising moving a robot between the first and second workstations to perform the robotic work on the first and second workpieces.

6. The method of claim 1 wherein the first and second workpieces are rotated and translated during movement to and from the first and second workstations, respectively.

7. The method of claim 1 wherein the first and second holders alternate movements to and from the first station.

8. The method of claim 1 wherein the first and second holders load and unload the first and second workpieces, respectively, only at the first station.

9. The method of claim 9 wherein the first and second holders hold the first and second workpieces, respectively, during the robotic work.

10. A method of positioning workpieces for robotic work, comprising;
alternatingly loading first and second workpieces onto first and second holders, respectively, at a first location;
alternatingly moving the first and second holders with the first and second workpieces from the first location to a first and second workstations, respectively, for work by a robot; and
alternatingly moving the first and second holders with the first and second workpieces from the first and second work stations, respectively, to the first location for unloading the first and second workpieces from the first and second holders, respectively, after the work is done on the first and second workpieces.

11. The method of claim 10 wherein the first and second holders move on opposite sides of the first and second workstations.

12. The method of claim 10 wherein the first and second holders are at the first and second workstations at different times.

13. The method of claim 10 wherein the first and second workpieces remain on the first and second holders, respectively, in the first and second workstations as the work is done.

14. The method of claim 10 wherein the holders do not unload the workpieces at the first and second workstations.

15. The method of claim 10 wherein the first and second holders rotate and translate the first and second workpieces during movement from and to the first location.

16. The method of claim 10 wherein the robot moves between the first and second workstations.
